(19) United States
(12) Patent Application Publication
(10) Pub. No.: US 2012/0212435 A1
(43) Pub. Date: Aug. 23, 2012

(54) APPARATUS AND METHOD FOR OPERATING TOUCH PAD IN PORTABLE DEVICE

(75) Inventor: HanKook BAE, Suwon-si (KR)

(73) Assignee: Samsung Electronics Co. Ltd., Suwon-si (KR)

(21) Appl. No.: 13/397,984

(22) Filed: Feb. 16, 2012

(30) Foreign Application Priority Data
Feb. 18, 2011 (KR) 10-2011-0014413

(51) Int. Cl. G06F 3/041

(52) U.S. Cl. 345/173; 178/18.03

(57) ABSTRACT

An apparatus and a method for controlling a touch input in a portable terminal are provided. In the method, a touch pad is activated when a request for a touch activation mode is received. Whether a touch input is received from the touch pad is determined. The touch input is compared with patterns of a pattern table of a corresponding application, wherein the patterns of the pattern table are mapped to an operation control command of the corresponding application. When an input pattern of the touch input matches with a pattern registered in the pattern table, an operation of the corresponding application that is currently running is controlled to perform a function corresponding to the matched pattern.

### PRIORITY

This application claims the benefit under 35 U.S.C. §119(a) of a Korean patent application filed on Feb. 18, 2011 in the Korean Intellectual Property Office and assigned Serial No. 10- 2011-0014413, the entire disclosure of which is hereby incorporated by reference.

### BACKGROUND OF THE INVENTION

1. Field of the Invention

The present invention relates to an input apparatus and a method of a portable terminal More particularly, the present invention relates to an input apparatus and a method of a portable terminal using a touch pad.

2. Description of the Related Art

A general trend in the design of portable terminals is to employ a touch screen that integrates a touch pad with a display unit. The display unit may include a Liquid Crystal Display (LCD) and the touch pad can be of a capacitive or resistive type. In a portable terminal employing a touch screen, a touch input can occur only when a specific area is touched while the display unit is operating. In other words, since the display unit and touch pad operate together, the touch pad cannot perform an input function when the display unit is turned off.

However, some of the applications run by the portable terminal can perform their functions without requiring operation of the display unit. For example, a music player (e.g., an MP3 player) can operate a control key for performing a playback function without the display unit being turned on. However, even though a user does not need to view the display unit, the display unit is turned on and a touch function is activated for control of the playback function through analyzing of a touch input. In other words, in order to control an operation of the portable terminal using a touch function, the display unit is turned on to display a touchable area (or a function to be touched), and the touch pad recognizes a specific input or command by detecting the user's touch on a corresponding area.

That is, even when the application does not need the display unit's operation, the display unit is turned on to display a touchable area (or key) and when the corresponding area (or key) is touched, a corresponding function is performed. Thus, the display is unnecessarily turned on, which wastes power and may cause the user an inconvenience if other functions become unavailable due to a lack of power.

### SUMMARY OF THE INVENTION

Aspects of the present invention are to address at least the above-mentioned problems and/or disadvantages and to provide at least the advantages described below. Accordingly, an aspect of the present invention is to provide a method of activating a touch input while a display unit is turned off

Yet another aspect of the present invention is to provide a method of activating a touch input while a display unit is turned off when executing an application that does not need a display function.

Still another aspect of the present invention is to provide a method of activating a touch input while a display unit is turned off and analyzing a touch input to perform a related function in a portable terminal using a touch screen.

According to an aspect of the present invention, a touch input method in a portable terminal is provided. The method includes activating a touch pad when a request for a touch activation mode is received, identifying whether a touch input is received from the touch pad, comparing an input pattern of the touch input with patterns of a pattern table of a corresponding application, wherein the patterns of the pattern table are mapped to an operation control command of the corresponding application, and controlling, when the input pattern of the touch input matches with a pattern registered in the pattern table, an operation of the corresponding application that is currently running to perform a function corresponding to the matched pattern.

According to another aspect of the present invention, a touch input apparatus in a portable terminal is provided. The apparatus includes a touch pad coupled with a display unit, a memory for storing a pattern table in which patterns are matched to an operation control command of corresponding applications in a touch activation mode, and a controller for activating the touch pad when a request for the touch activation mode is received, for comparing a touch input received from the touch pad with the pattern table of the memory, and for controlling, when an input pattern of the touch input matches with a pattern registered in the pattern table, an operation of an application to perform a function of a corresponding pattern.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a configuration of a portable terminal according to an exemplary embodiment of the present invention;

FIG. 2 is a view illustrating a controller for processing a touch input according to an exemplary embodiment of the present invention;

FIG. 3 is a view illustrating an example of a pattern table according to an exemplary embodiment of the present invention; and

FIG. 4 is a flowchart illustrating an operation procedure for processing a touch input in a touch activation mode according to an exemplary embodiment of the invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for controlling an operation of a portable terminal using a full touch function (e.g., a cellular phone, an MP3 player, a tablet device, etc.) through simplified touch recognition without driving a display unit. According to exemplary embodiments of the present invention, in a portable terminal with a full touch function, a specific pattern is set and registered in advance and, when performing a function that does not require an operation of the display unit, a touch pad is activated while the display unit is turned off When a specific pattern of a touch on the touch pad is detected, the portable terminal performs a function that corresponds to the specific pattern.

In the following description, the term “touch activation mode,” as used herein, may refer to a mode in which only the touch pad is activated so that a touch input can occur while the display unit is turned off. In the touch activation mode, the display unit stops operating (i.e., the display unit does not consume power) while power is supplied to the touch pad, and the controller can apply a normal scan control signal and detect whether the touch pad is touched through a scan detection port.

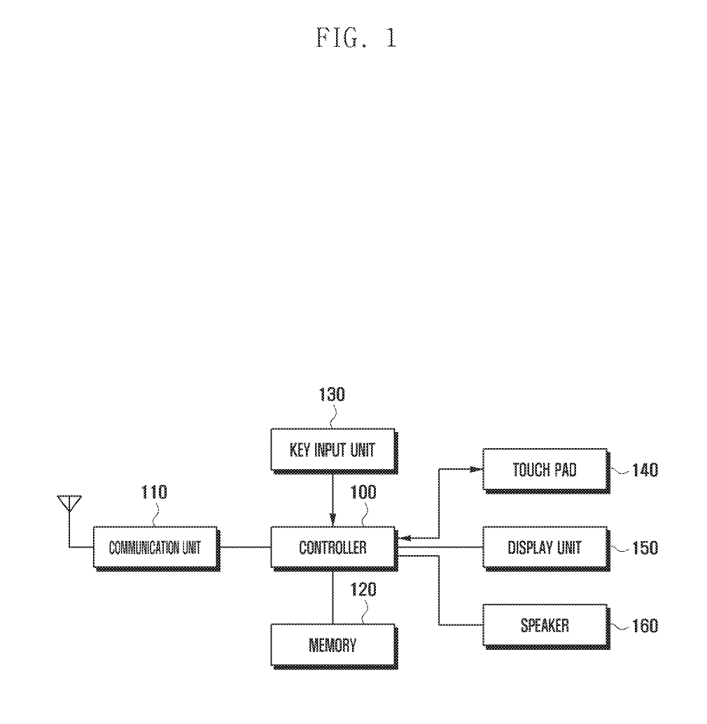

FIG. 1 is a view illustrating a configuration of a portable terminal according to an exemplary embodiment of the present invention.

Referring to FIG. 1, the portable terminal may include a controller 100, a communication unit 110, a memory 120, a key input unit 130, a touch pad 140, a display unit 150, and a speaker 160.

The communication unit 110 transmits and receives a Radio Frequency (RF) of the portable terminal. The communication unit 110 may include an RF transmission unit for up-converting and amplifying a baseband frequency of a transmission signal to an RF band. The communication unit 110 may also include an RF receiver for low-noise amplifying an RF band signal and down-converting the RF band signal to a baseband signal. Also, the communication unit 110 may include a modulator-demodulator. In this case, the modulator can modulate the transmission signal to produce the baseband signal and the demodulator can demodulate the baseband signal.

The controller 100 controls an overall operation of the portable terminal. For example, the controller 100 may control an execution of an application by activating a touch pad while the display unit is turned off according to an exemplary embodiment of the present invention. The controller 100 can turn on and off a touch activation mode according to a preset external key. Also, the controller 100 can provide a touch activation mode setup menu in a setup mode and enter the touch activation mode when a user selects the touch activation mode. According to an exemplary embodiment of the present invention, the touch activation mode is set by a specific external key. The controller 100 can turn off the display unit in the touch activation mode, analyze a touch input, and control a corresponding function of the portable terminal according to the analysis result.

The memory 120 stores an operation program of the portable terminal More particularly, the memory 120 can include a program table that stores a program for processing a touch pad input according to an exemplary embodiment of the present invention. Also, the memory 120 stores a pattern table for determining the touch input according to an exemplary embodiment of the present invention. Further, the memory 120 can have a data memory that temporarily stores data generated during an operation of the program. Here, the pattern table can be provided for each application, and the pattern table has preset data for controlling an operation of a corresponding application in the touch activation mode, wherein the control data is matched to the preset pattern. Here, the patterns can be set as a character, a number or a figure, and can be set by the user.

The touch pad 140 and the display unit 150 are integrated into a touch screen apparatus, wherein each of the touch pad 140 and the display unit 150 has a separate power port. The display unit 150 displays according to each function of the portable terminal under the control of the controller 100. The touch pad 140 is activated to detect a touch input when the display unit 150 is operated and transmits the detected touch input to the controller 100. Also, in the touch activation mode, the display unit 150 stops operating and the touch pad 140 maintains its activated status. When a touch is generated on the touch pad, a change in physical quantity (e.g., capacitance or resistance) is generated and the controller 100 can detect such change.

The key input unit 130 includes external keys mounted on the portable terminal, each of which can serve as a function key for performing a specific function. The function key, for example, can include a hold key, an up/down key, a menu key, and the like. According to an exemplary embodiment of the present invention, one of the function keys is set to be used to enter into the touch activation mode. The hold key is a function key that drives an operation of the display unit 150 when the key is pressed for over a certain period (i.e., a long key input). According to an exemplary embodiment of the present invention, the key serves as a function key that enters into the touch activation mode when the hold key is pressed for less than the certain period (i.e., a short key input). Alternatively, according to an exemplary embodiment of the present invention, when the short key input occurs twice in a consecutive order, the touch activation mode is entered.

The speaker 160 performs to output an audio signal that is generated or reproduced in the portable terminal

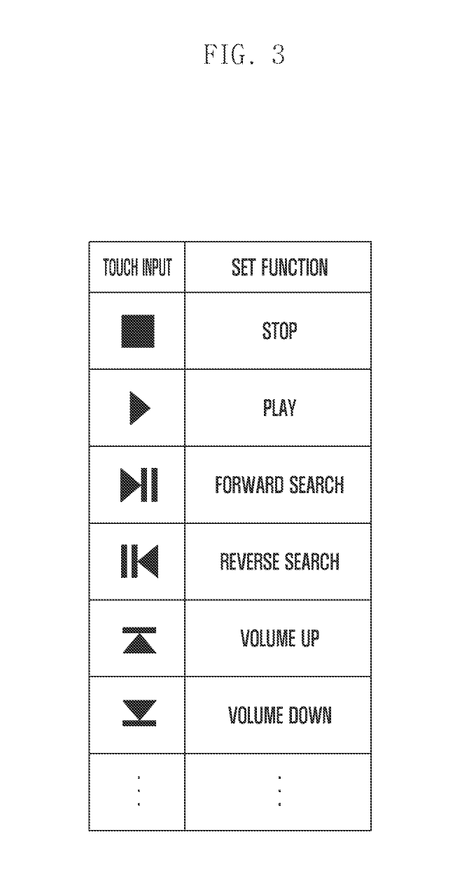

In an exemplary portable terminal having a configuration as described above, an operation in the touch activation mode is described. First, in order to detect a touch input in a touch activation mode, a table as shown in FIG. 3 may be set and registered in the memory 120 in advance. Because the display unit 150 is turned off in the touch activation mode, it is difficult for a user to perform an input function without viewing a specific user interface or other display on the display unit 150. Therefore, according to an exemplary embodiment of the present invention, a specific pattern to be used in the touch activation mode is set in advance and registered in a table (hereafter, referred to as ‘pattern table’). Based on the specific pattern, the touch input can be recognized. The pattern can be any of a symbol, a character, a number, and the like. The pattern can be created on the touch pad 140 by the user using any of a touch, a drag, a drop, and similar gestures. The controller 100 detects the pattern created on the touch pad 140 and compares the detected pattern with the preset pattern registered in the pattern table to determine a corresponding control command.

FIG. 3 is a view illustrating an example of a pattern table according to an exemplary embodiment of the present invention. In the example of FIG. 3, commands for controlling an MP3 player in an MP3 playback mode are shown. Of course, it is to be understood that this is merely for convenience of description and not to be construed as limiting. That is, the patterns and corresponding control commands may be set by the user in the setup mode of the portable terminal and registered in the pattern table for any function of the portable terminal such as the MP3 function. Also, the pattern table as shown in FIG. 3 can be set as default by a manufacturer.

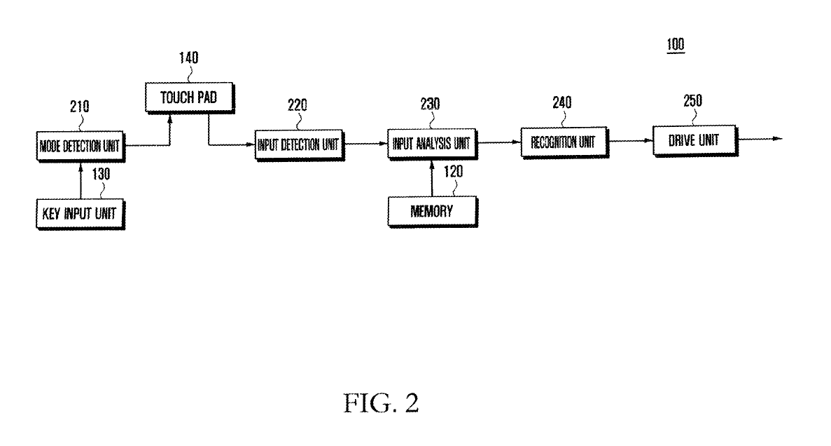

FIG. 2 is a view illustrating a controller for processing a touch input according to an exemplary embodiment of the present invention.

Referring to FIG. 2, the controller 100 may include a mode detection unit 210, an input detection unit 220, an input analysis unit 230, a recognition unit 240, and a drive unit 250.

The mode detection unit 210 detects a mode by analyzing a key input signal received from the key input unit 130. In an exemplary implementation, the mode detection unit 210 detects selection of a touch activation mode for activating the touch pad 140 when a specific key is entered. The specific key can be the hold key, and the mode detection unit 210 may detect the touch activation mode when the short key input is generated twice from the hold key in a consecutive order. When the touch activation mode is entered, the mode detection unit 210 turns off the display unit 150 and activates an operation of the touch pad 140 by applying a scan control signal to the touch pad 140. Here, the touch pad 140 receives the scan control signal output from the controller 100 and outputs a touch position and a change in physical quantity to the controller 100 through a scan detection port. The controller 100 stops operating the display unit 150 in the touch activation mode.

The input detection unit 220 is connected to the scan detection port of the touch pad 140 and detects a touch input received on the touch pad 140. The touch input can be a specific pattern, number, character data, and the like. For example, the user can generate an input having the specific pattern by performing touch and drag gestures on the touch pad 140. The input detection unit 220 detects the pattern generated on the touch pad 140 through the scan detection port.

In an exemplary implementation, the mode detection unit 210 and the input detection unit 220 can be a touch pad controller. In this case, the touch pad controller may be connected to a scan control port and the scan detection port of the touch pad 140 to output the scan control signal to the touch pad 140 and receive a scan detection signal from the touch pad 140.

The input analysis unit 230 compares the pattern detected by the input detection unit 220 with the pattern preset and registered in the pattern table of the memory 120. The input analysis unit 230 can be a pattern comparison unit or a pattern analysis unit. The recognition unit 240 recognizes the user's input using an analysis result output from the input analysis unit 230. Here, the recognition unit 240 creates a command for driving the input data or a corresponding application according to a recognition result. The drive unit 250 processes the input data or drives a corresponding driver according to the output of the recognition unit 240.

As described above, the touch input can be the specific pattern entered by the user and thus the input detection unit 220 can be a pattern detection unit, and the input analysis unit 230 can be the pattern analysis unit or the pattern comparison unit that compares an input pattern with the preset pattern.

Referring to FIGS. 1 through 3, patterns to be used in the touch activation mode need to be registered in the pattern table, as shown in FIG. 3, of the memory 120 of the portal terminal The manufacturer can set and register the patterns in the pattern table, and the user also can set and register desired patterns in the pattern table in a registration mode or the setup mode of the portable terminal The patterns can be used as an input for controlling an operation of a specific function. The specific function is operated in the touch activation mode that activates only the touch pad 140 while the display unit 150 is turned off For example, the specific function can be an MP3 playback function.

When the user executes a function or an application that does not require the operation of the display unit 150, a preset key of the key input unit 130 can be used to start the touch activation mode. The key can be a specific key of the key input unit 130. In an exemplary embodiment of the present invention, it is assumed that the short key input is received, i.e., the hold key is entered twice in a consecutive order. The controller 100 detects the short key input and operates the touch activation mode in which the display unit 150 is turned off and the scan control signal is output to the touch pad 140. When the touch activation mode is operated, the mode detection unit 210 detects the event, turns off the display unit 150, and outputs the scan control signal to the touch pad 140. Thus, when the user enters the touch activation mode, the display unit 150 is turned off and the touch pad 140 is activated while the controller 100 performs a corresponding function (e.g., an MP3 playback function).

When the user draws (enters) a pattern for executing a specific operation on the touch pad 140 in the touch activation mode, the input detection unit 220 detects the pattern drawn by the user through the scan detection port. The pattern entered by the user is compared by the input analysis unit 230 with the patterns registered in the pattern table of the memory 120 to determine whether an identical pattern exists. If the identical pattern exists, the recognition unit 240 identifies a function corresponding to the input pattern from the pattern table of the memory 140, and controls the drive unit 250 to perform the corresponding function. The drive unit 250 performs the operation according to the user's input.

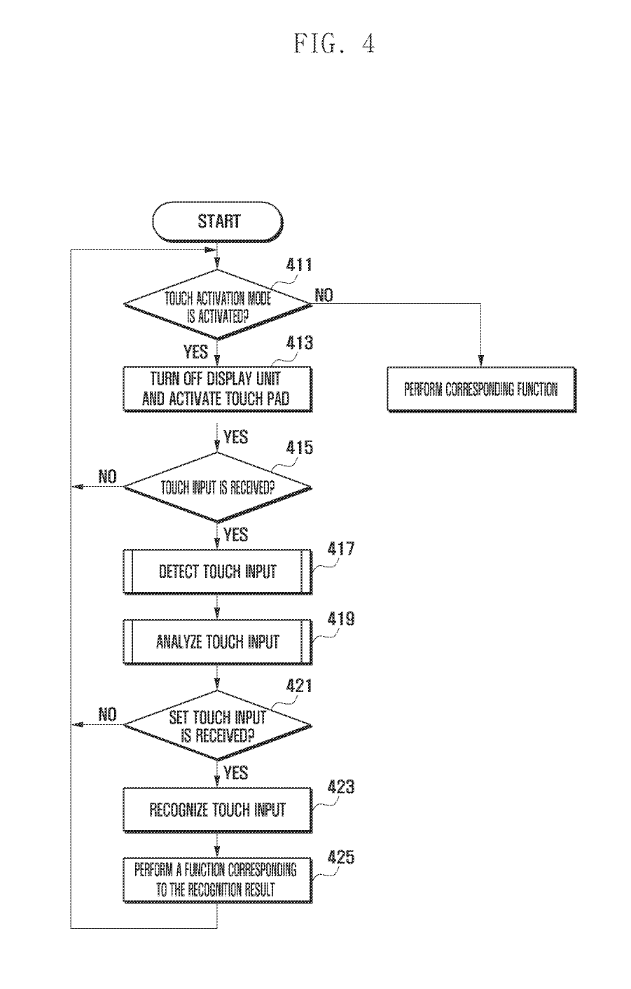

FIG. 4 is a flowchart illustrating an operation procedure for processing a touch input in a touch activation mode according to an exemplary embodiment of the present invention.

Referring to FIG. 4, the controller 100 determines whether the touch activation mode is activated in step 411. Here, as described above, the touch activation mode is a mode that activates only the touch pad 140 while the display unit 150 is turned off In an exemplary implementation, the touch activation mode can be driven by a specific key of the key input unit 130. If it is determined in step 411 that the touch activation mode is entered, the controller 100 turns off the operation of the display unit 150 and activates the touch pad 140 in step 413. When the touch activation mode is entered, a display operation of the display unit 150 is stopped and the scan control signal is applied to the touch pad 140.

In the touch activation mode, the controller 100 performs a function selected by the user. For example, when the MP3 playback function is operated, the controller 100 reproduces music through a speaker. In this circumstance, the user can generate a command for controlling a function that is currently operated through the touch input. In step 415, it is determined if the user generates a touch input on the touch pad 140. If it is determined in step 415 that a touch input is received, the controller 100 identifies such event and detects a pattern according to the touch in step 417. Here, the controller 100 may detect the pattern by detecting a track of a drag operation of the user after the touch input. After detecting the touch input, the controller 100 analyzes the touch input by comparing the touch input with the patterns registered in the pattern table of the memory 120 to identify whether there exists an identical pattern in step 419. In step 421, the controller 100 determines whether set touch input is received by determining if an identical pattern exists in the memory 120. In step 423, the controller 100 recognizes the touch input by identifying a function corresponding to the identical pattern. In step 425, the controller 100 controls performance of a corresponding function to be operated according to the recognized touch input.

The controller 100 repeats the above process when the touch activation mode is operated. If the user terminates the touch activation mode through the key input unit 130, the controller 100 detects such an event in step 411 and performs a corresponding function set by the user. The termination of the touch activation mode can be performed by a specific key of the key input 130. For example, when the ‘hold key,’ which is a function key that turns off a lock mode of the portal terminal, is pressed for over a certain period (i.e., a long key input), the lock mode of the portal terminal is turned off Accordingly, when the hold key is pressed for a long time, the controller 100 detects this and turns off the touch activation mode in step 411. When the touch activation mode is off, the controller 100 turns on the display unit 150 so that the display function can be performed.

In the above example, it is assumed that the pattern table of the memory 120 is set as shown in FIG. 3, the MP3 playback function is currently operated, and the touch activation mode is turned on. In that situation, when the user draws a specific pattern on the touch pad 140, the controller 100 compares the touched pattern with the patterns registered in the pattern table to control the operation of the MP3 playback function. If the user draws a pattern of ‘,’ in other words an outline of a square, the controller 100 recognizes the pattern as a ‘stop’ command and stops the MP3 playback function by performing steps 417 to 423. Also, when the user draws a pattern of ‘ [symbol] ,’ in other words the outline of a forward arrow, the controller 100 recognizes the pattern as a ‘play’ command and plays a song selected in an MP3 mode by performing steps 417 to 423. Here, when a pattern for a forward search or a reverse search for selecting a previous or next song is detected, the controller 100 can play the searched song without an input of the ‘ [symbol] ’ pattern. Also, a volume of music can be controlled by using a volume up/down pattern. Of course, it is to be understood that these examples are merely for convenience of description and not intended to limit application of the present invention. That is, the present invention may be applied to any function supported by the portable terminal which receives a control input using the touch pad 140. Moreover, while FIG. 3 illustrates specific symbols corresponding to certain functions of an MP3 playback function, these are merely exemplary. As an example, rather than drawing the outline of a forward arrow to execute a play function, a user may input a drag motion from one side of the touch pad 140 to the other side. Such input functions may be set by the user.

According to exemplary embodiments of the present invention, a portable terminal having a full touch function (e.g., a mobile phone, an MP3 player, or the like) can be controlled by simple touch recognition without the driving of a display unit. Accordingly, a user can conveniently use the terminal and unnecessary power consumption can be reduced, so that the performance of portable terminal can be enhanced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch input method in a portable terminal, the method comprising:
activating a touch pad when a request for a touch activation mode is received;
identifying whether a touch input is received from the touch pad;
comparing an input pattern of the touch input with patterns of a pattern table of a corresponding application, wherein the patterns of the pattern table are mapped to an operation control command of the corresponding application; and
controlling, when the input pattern of the touch input matches with a pattern registered in the pattern table, an operation of the corresponding application that is currently running to perform a function corresponding to the matched pattern.

2. The method according to claim 1, wherein a display unit is turned off when the touch activation mode is activated.

3. The method according to claim 2, wherein the touch activation mode is activated in an MP3 playback mode.

4. The method according to claim 2, wherein the input pattern comprises at least one of a character, a line, and a figure.

5. The method according to claim 2, wherein the touch activation mode is set by a specific external key.

6. The method according to claim 1, further comprising:
entering a setup mode of the portable terminal; and
setting the patterns of the pattern table.

7. The method according to claim 6, further comprising selecting an application corresponding to the patterns before the setting of the patterns of the pattern table.

8. A touch input apparatus in a portable terminal, the apparatus comprising:
a touch pad coupled with a display unit;
a memory for storing a pattern table in which patterns are matched to an operation control command of corresponding applications in a touch activation mode; and
a controller for activating the touch pad when a request for the touch activation mode is received, for comparing a touch input received from the touch pad with the pattern table of the memory, and for controlling, when an input pattern of the touch input matches with a pattern registered in the pattern table, an operation of an application to perform a function of a corresponding pattern.

9. The apparatus according to claim 8, wherein the controller comprises a touch pad controller which, in the touch activation mode, turns off an operation of the display unit and outputs a scan control signal to the touch pad and detects an output of a scan detection port of the touch pad to detect a touch.

10. The apparatus according to claim 9, further comprising:
a key input unit including a specific key configured to generate a command for the touch activation mode, wherein the controller performs the touch activation mode when the specific key is entered.

11. The apparatus according to claim 10, wherein the touch activation mode does not require a display function of the display unit.

12. The apparatus according to claim 11, wherein the pattern comprises at least one of a character, a line, and a figure.

13. The apparatus of claim 8, wherein the controller comprises an input analysis unit for comparing the touch input received from the touch pad with the pattern table of the memory,

14. The apparatus of claim 13, wherein the input analysis unit comprises at least one of a pattern comparison unit and a pattern analysis unit.

15. The apparatus according to claim 8, wherein the controller enters a setup mode of the portable terminal, and sets the patterns of the pattern table.

16. The apparatus according to claim 15, wherein the controller selects an application corresponding to the patterns before setting the patterns of the pattern table.
